(19) United States
(12) Patent Application Publication
(10) Pub. No.: US 2020/0360890 A1
(43) Pub. Date: Nov. 19, 2020

(54) ACOUSTIC WAVES TREATMENT DEVICE AND METHOD

(71) Applicants: Gil CHING, Le Bar Sur Loup (FR); UNIVERSITE D'AVIGNON ET DES PAYS DE VAUCLUSE, Avignon Cedex 01 (FR)

(72) Inventors: Gil CHING, Le Bar Sur Loup (FR); Huguette SALLANON, Chateauneuf De Gadagne (FR); Florence CHARLES, Cabannes (FR)

(21) Appl. No.: 16/766,137

(22) PCT Filed: Nov. 19, 2018
(86) PCT No.: PCT/EP2018/081808

§ 371 Date: May 21, 2020

(30) Foreign Application Priority Data
Nov. 22, 2017 (FR) 1771244

(51) Int. Cl. B01J 19/10; C02F 1/36

(52) U.S. Cl. CPC B01J 19/10; B01J 2219/0877; C02F 1/36

(57) ABSTRACT

A device for acoustic wave treatment has an open elongated vessel, whose cross-section tapers progressively towards an opening on the top of said vessel, and a piezoelectric element. The vessel is filled with a liquid and the piezoelectric element emits waves into the liquid. The waves are focused near the opening of the vessel and emerge in a duct.

The invention relates to an associated device or system and a method to treat products with acoustic waves. More particularly, the invention relates to the use of a device or system for the treatment and/or decontamination of solid and/or liquid products, such as for example polluted water.

In France, the estimated full annual cost of cleaning up agricultural and livestock surpluses in surface and coastal waters amounts to more than 50 billion euros. In addition, there is the need to clean up domestic water, water from the food and pharmaceutical industries. The purpose of sonochemistry is to mineralize the organic matter in water, whether it is of natural origin (waste from living matter) or synthetic origin (pesticides or medicines for example).

The purpose of wastewater treatment is to maintain the integrity of the environment and to preserve water sources for human consumption, thus minimizing the release of organic matter into the environment. Directive 98/83/EC concerns the quality of water intended for human consumption. It sets standards for drinking water and aims to protect human health from the harmful effects of the contamination of water intended for human consumption by ensuring that it is safe and clean.

The most effective solution to deal with water pollution continues to be the implementation of preventive rather than curative measures. In fact, the cost of curative treatment can be up to 87 times more than preventive treatment.

With regard to water pollution from agricultural processes, the Ecophyto plan initiated in 2008 aimed to reduce the use of phytosanitary products. The new Ecophyto plan reaffirms the objective of reducing the use of phytosanitary products in France by 50% in ten years, following a two-step trajectory. Firstly, by 2020, the aim is to achieve a 25% reduction through the generalization and optimization of currently available techniques. Then a further 25% reduction by 2025, which will be achieved through more profound changes. By banning synthetic chemicals, organic agriculture preserves water quality and prevents its degradation. It is based above all on a set of agricultural and sanitary techniques and on a global approach to the production system. All of these agricultural practices also contribute to greatly reducing the risk of leaching. An INRA study in 2003 ranked Organic Agriculture as the most favourable practice for high-quality water.

However, even though Organic Agriculture is booming, it now represents only a small portion of agricultural land. Thus, the useful agricultural area for Organic Agriculture represents only 0.1% in Africa, 0.8% in North America, 1.1% in Latin America, 0.3% in Asia, 2.4% in Europe and 4.1% in Oceania.

In light of the above, there is now a need to continue combating water pollution effectively and therefore improving or developing new pollution control devices.

The National Drug Residue Plan (PNRM) aims to assess the possible risk linked to the presence of drug-related molecules in water and the possible consequences for the ecosystem and humans. They also aim to initiate actions to reduce drug dispersion in water. In fact, drugs are molecules manufactured to be biologically very active. In addition, they belong to families of very diverse chemical structures. When a drug is taken by a person or when it is administered to an animal, some of it is not fully used or broken down in the body. It is these “drug residues” that will be excreted in faeces and urine, thus reaching the sewage system or the environment.

There are also drugs that are thrown directly “down the drain” rather than being taken back to the pharmacy for recycling. At present, it is estimated that the pool of unused drugs is between 24,000 and 29,000 tonnes per year. Some of which go down the drain.

As a result, domestic wastewater also contains organic matter or suspended solids as well as pesticide and/or drug residues. At present, they are essentially purified by activated sludge treatment plants which allow part of the organic matter to be eliminated but which generate waste, the sludge, which is considered as final waste and must therefore be incinerated, which generates a significant energy cost. The elimination of pesticides and drugs is therefore only very partial.

Likewise, water from food-processing is only very partially treated and water relatively loaded with organic matter and pesticides reaches the domestic water network. For example, the high organic matter load of fruit and vegetable washing water is an obstacle to water recycling. The use of filters is possible but quickly leads to clogging, which favours the use of open circuits and therefore large quantities of water.

Due to the solubility of pesticides and many drugs, conventional water treatment processes (clarification, sand filtration, disinfection) are generally ineffective in removing them. Specific treatments such as adsorption on activated carbon or membrane filtration must then be considered.

Even though activated carbon filters of proven efficiency exist today, the limitations of activated carbon require a very regular change of refills, making their use tedious, costly and even polluting when the recycling of filters is not ensured.

A Granular Activated Carbon (GAC) adsorption water treatment system is described in EP3009405. The process describes a treatment step in which the water to be treated is brought into contact with a pulverulent adsorbent material in order to reduce the content of organic matter and pollutants such as pesticides, endocrine disruptors, industrial residues and drug residues.

Even if there are many proposals for alternatives to traditional decontamination processes, nowadays their use is minimal or not used at all. One of the main reasons for this is that these alternatives generate significant costs that represent a major brake on investment.

Health consequences of aquatic pollutants are numerous today. Some chemical molecules in pesticides are reprotoxic, mutagenic and even carcinogenic.

Finally, aquatic pollution has a direct impact on other sectors such as fishing and oyster farming, sometimes making them irreversibly fragile even though they represent a major economic and social burden.

Considering the above, in order to solve these problems and especially to develop an alternative allowing in particular the depollution of water, the Applicant has developed new equipment and technology that is environmentally friendly for an optimized treatment of solid and liquid products, preferably polluted water, while limiting the undesirable effects observed in the previous art.

Such technology is advantageously called “green”, i.e. without the addition of chemical contaminants, without any release to the environment and without the production of by-products harmful to health.

The first objective of this invention is therefore a device comprising at least:

an open elongated vessel whose cross-section tapers progressively towards an opening in the upper part of said vessel, and- a piezoelectric element,

wherein said vessel is filled with a liquid; and in that the piezoelectric element is adapted to emit waves into said liquid, said waves being focused in the vicinity of the opening of the vessel and exiting into a duct.

The second objective is a system comprising at least two devices according to the invention, wherein the outlets of the various ducts converge into a flow collector.

The third objective is the use of a device or system according to the invention, for cleaning and/or decontaminating liquid and/or solid products.

The fourth objective is the use of a device or system according to the invention, for:

the extraction of active ingredients;

the solubilization or homogenization of liquid and/or solid products in the liquid;

the manufacturing of emulsion;

the preparation of colloids; and/or chemical compounds.

The fifth objective is a process for treating a solid product located in the vessel, in and/or at the outlet of the duct, with high-frequency acoustic waves, wherein it comprises the following steps according to which:

a liquid is introduced into the vessel of a device according to the invention by a flow circuit;

high-frequency acoustic waves of more than 100 kHz, preferably more than 200 kHz, are generated in said vessel by the piezoelectric element;

the acoustic waves propagate in the vessel and focus at a point located in the vicinity of the central part of the opening of the vessel and exit into the duct; said waves allowing the treatment of the solid product; and

the solid product thus treated is recovered.

Finally, the sixth objective is a process for treating a liquid with high-frequency acoustic waves, wherein it comprises the following steps according to which:

the liquid to be treated is introduced into the vessel of a device according to the invention by means of a flow circuit;

high-frequency acoustic waves of more than 100 kHz, preferably more than 200 kHz, are generated in said vessel by the piezoelectric element;

the acoustic waves propagate in the vessel and focus at a point near the central part of the opening of the vessel and exit into the duct; said waves allowing the treatment of the liquid; and

the liquid thus treated is recovered at the outlet of the duct or at the outlet of the flow collector.

The invention and the advantages deriving therefrom will be better understood by reading the following description and the non-limiting methods of implementation, written in relation to the annexed figures in which:

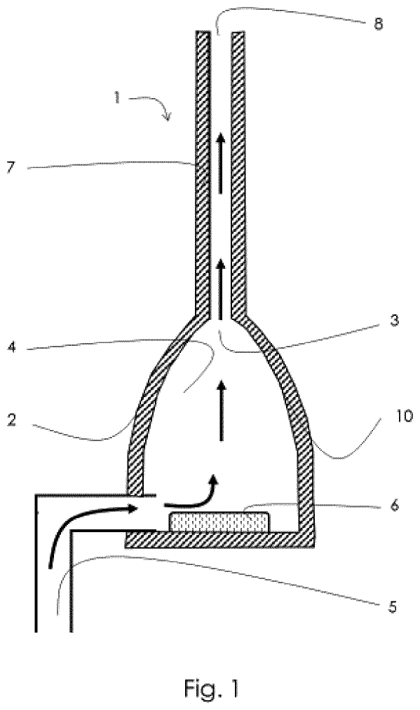

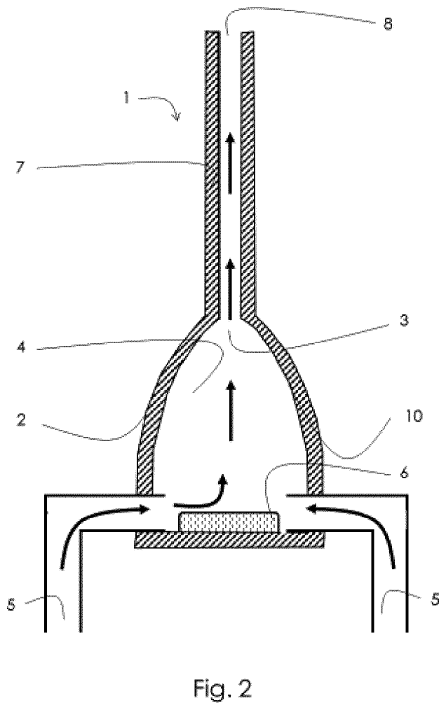

FIGS. 1 and 2 represent schematic sections of preferred ways to make devices according to the invention;

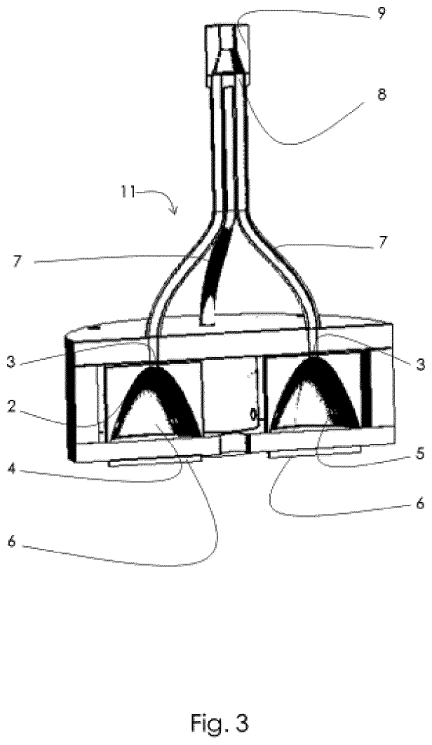

FIG. 3 represents a schematic diagram of a system integrating several devices according to the invention; and

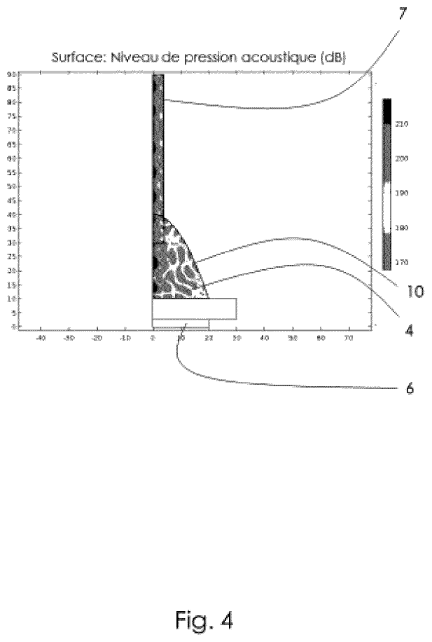

FIG. 4 illustrates the focusing of the acoustic waves in the vessel or parabola and in the outlet duct or tube of the device according to the invention.

The invention relates to a device for treating products with acoustic waves.

As shown in FIGS. 1, 2 and 3, the device comprises:

a vessel 2 preferably in the form of a paraboloid of revolution whose focal point is preferably located in the vicinity of the central part of the opening 3 of vessel 2, and

a duct 7, or outlet tube,

in which acoustic waves propagate.

The Applicant was able to demonstrate, as shown in FIG. 4, that the acoustic focusing in the parabola and in the outlet tube 7 in particular allows for optimized water cleaning.

In fact, FIG. 4 shows that the sound pressure maxima are located in duct 7.

As illustrated in FIGS. 1, 2 and 3, the objective of this invention is a device 1 comprising an elongated vessel 2 closed at one end on which a piezoelectric element 6 is mounted capable of emitting waves in a liquid 4.

The elongated vessel 2 according to the invention is preferably in the form of a parabola. This open elongated vessel 2 is thus an acoustic focusing reactor.

According to the invention, the wall 10 of the vessel 2 and possibly of the duct 7 are made of hard materials, capable of reflecting the waves, and are preferably shaped so as to focus the waves at a point located near the central part of the opening 3 of the vessel or in the central part of the duct 7.

According to this invention, hard material means a material hard enough to reflect waves by absorbing minimal energy. Preferably the hard material is selected from stainless steel, borosilicate glass, quartz, or a metal having an impedance break with respect to the fluid being treated and compatible with the fluid to be treated.

According to the invention, duct 7 is made of suitable dimensions and material, and duct 7 is the seat of acoustic propagation. This duct can be a rigid circular tube with a constant circular cross section or a variable cross section. The tube diameter is preferably between 1 mm and 200 mm, more preferably between 4 mm and 50 mm.

According to the invention, duct 7 may be made of a so-called flexible or elastic material, i.e., the diameter of the tube varies with the pressure in the tube or is rigid, in which case the diameter of the tube is independent of the internal pressure. For example, when the hose is very flexible, the propagation speed is lower and thus the wavelength in duct 7 is reduced.

Thanks to the piezoelectric element 6, acoustic waves are generated in vessel 2, which is necessarily filled with a liquid 4. The piezoelectric element 6 is preferably a piezoelectric ceramic or an assembly of piezoelectric ceramics.

The family of piezoelectric ceramics includes many elements, such as barium titanates (BaTiO3) or Lead Zircono Titanates (PZT or LZT for Lead Zirconate Titanate), which are the most widespread and which alone have five to six different compositions. Preferably, the ceramics used are PZT (Lead Zirconate Titanate) ceramics such as PZT-4, PZT-5 or PZT-8.

More preferably, the ceramics used are ceramics for acoustic emission with a quality factor higher than 500 such as PZT-5.

The piezoelectric element 6, which is preferably one or a set of piezoelectric ceramics, can be arranged on the outer and/or inner walls of vessel 2.

Piezoelectric ceramics can be present on all types of walls, both horizontal and vertical.

Alternatively, the piezoelectric element can be materialised by any system capable of generating acoustic waves of predefined frequencies, for example mono crystals or composite ceramics.

The device subject to the invention comprises a liquid 4 which is preferably water and which allows the propagation or diffusion of waves in vessel 2 and in duct 7.

As shown in FIGS. 1 and 2, the liquid 4 is led into vessel 2 via one or more flow circuits 5.

Preferably, liquid 4 can be:

a liquid to be treated, or

a treatment liquid allowing the treatment of a product located in vessel 2, in and/or at the outlet of duct 7.

The liquid 4 to be treated contained in vessel 2 can for example be:

water to be made drinkable;

water containing active ingredients to be removed such as pesticides; and/or

water containing microorganisms (viruses, bacteria, etc.) to be neutralized.

The process liquid 4 contained in vessel 2 can for example be:

water,

calcium oxide or quicklime, which is generally used mixed with 10% water;

hypochlorites and in particular sodium hypochlorite or bleach, which is generally used mixed with water;

chlorine dioxide;

sodium chlorite;

sodium chlorate;

potassium chlorate;

alcohol, which is usually either ethanol or isopropanol;

hydrogen peroxide or oxygenated water;

iodine;

ozone;

phenol and phenolic compounds;

potassium permanganate;

quaternary ammonium salts;

toluene; and/or

vinegar or acetic acid;

said above components being used alone or as a mixture for the preparation of the treatment liquid.

Preferably, treatment liquid 4 is water, either fresh or saline. More preferably, liquid 4 is fresh water. A non-exhaustive example of usable fresh water is drinking water such as mineral water, spring water or reverse osmosis water.

Preferably, the water used in device 1 according to the invention is drinking water.

Alternatively, to further increase the treating power of the device according to the invention, the water in the treatment liquid may contain one or more other treating agent(s) selected from detergents and/or disinfectants.

Detergents are agents whose mode of action is physical or physico-chemical.

A non-limiting list of detergents that can be used is as follows:

alkalis such as, in particular, soda, potash, carbonate and trisodium phosphate;

acids such as, in particular, phosphoric, nitric and acetic acids; and

chelating agents such as sodium pyrophosphate and EDTA (Ethylenediaminetetraacetic acid).

As a non-limiting example of usable disinfectants, we can quote:

halogens, in particular chlorine and its derivatives which are particularly easy to use and inexpensive, especially bleach (sodium hypochlorite) and sodium chlorocyanurates, or iodine derivatives;

oxides and peroxides such as hydrogen peroxide, ozone and peracetic acid;

aldehydes such as formaldehyde and glutaraldehyde;

surfactants and in particular quaternary ammoniums;

the acids often used for descaling;

bases more often associated with chlorine in the form of chlorinated alkalis;

alcohol; and

physical agents such as ionising radiation and UV rays.

As shown in FIG. 4, according to the invention, the waves generated in liquid 4 by the piezoelectric element are focused in the vicinity of the opening 3 of vessel 2. This acoustic focus that starts in the parabola is extended into duct 7 or outlet tube.

These generated acoustic waves will allow an optimal treatment of the liquid and/or solid products to be treated or modified.

Acoustic waves correspond to the propagation of mechanical disturbances in an elastic medium. According to the invention, the elastic medium is materialised by liquid 4.

Acoustic waves propagate in liquid 4 at velocity c (which in water is about 1500 m/s). Acoustic waves are temporally periodic (frequency f) and generate local disturbances in speed, pressure and temperature.

The spatial frequency is characterized by the wavelength

λ=c/f.

In some cases, the mechanical effects (pressure and speed variation) of US (ultrasonic) waves are used to put a strain on the solid/liquid interfaces, such as cleaning.

At liquid/solid interfaces, the pressure is maximal and the velocity is zero, the area of liquid very close to the solid surface is called the acoustic boundary layer.

As soon as this boundary layer is crossed, the influence of the wall disappears, so that in the boundary layer there is a very strong velocity and pressure gradient. All particles adhering to the solid walls are highly stressed and can be detached. Note that the thickness of this boundary layer is inversely proportional to the frequency of the wave. This principle is used in particular to clean the walls.

When the amplitude of the acoustic wave increases, the vacuum is such that a vapour bubble is formed, this bubble is excited at the frequency of the wave and evolves until cavitation and implosion occurs. This phenomenon is very energetic and destructive (to be avoided for cleaning). The implosion of these bubbles results locally in UV emission, a pressure wave of a few hundred atmospheres, “solar” temperatures and/or the creation of OH-free radicals. In literature there are an abundance of descriptions of the effects of cavitation, destruction of microorganisms, destruction of drugs up to their mineralization.

Each ceramic 6 is powered by an independent generator based on the resonance frequency of the ceramic.

Preferably, when several ceramics are used, as shown in FIG. 3, for example, each ceramic 6 in each device 1 of system 11 has its own resonant frequency. Two ceramics from the same batch do not have the same resonance frequency.

The adjustment module of the piezoelectric element 6, which is preferably a piezoelectric ceramic, is preferably a power electronic board. Thus, each piezoelectric ceramic is preferentially fed by a power electronic board providing it with an alternating voltage corresponding to its own vibration mode.

According to the invention, the piezoelectric element 6 of device 1 produces, in vessel 2, waves of a frequency higher than 100 kHz, preferably higher than 200 kHz. Preferably still, the frequency of the waves is higher than 500 kHz. Advantageously, the frequency of the waves produced in the enclosure is between 1 MHz and 5 MHz. Such high-frequency ultrasound above 1 MHz is also called megasonics.

The frequency of the ultrasounds or ultrasonic waves generated by the piezoelectric element 6 is fundamental. In fact, the principle of treatment (e.g. stimulation, transformation and/or decontamination) using device 1 according to the invention is based on the mechanical effects of the acoustic wave. The first effect of the presence of acoustic waves is to promote the dissolution of soluble products. In fact, the particle velocity of the acoustic wave renews the liquid in contact with the soiled part.

As shown above and illustrated in FIG. 4, the waves are focused at the vessel outlet 2 in an opening 3 and then channeled into a duct 7 also called outlet tube. This is due in particular to the fact that wall 10 of the device can be considered as an acoustic mirror which allows amplification by focusing acoustic waves. The wall or acoustic mirror 10 also allows a fluid flowing pipe. This makes it possible to have a focusing mirror with a double effect, namely acoustic focusing and fluid channeling.

The Applicant was able to demonstrate that it was possible to adapt the frequency of the acoustic wave according to duct 7, i.e. according to the reactor exhaust pipe or device 1. Thus, the fluid passes completely through the acoustic focusing zones.

Furthermore, duct 7 of the device which is subject to the invention can be designed and adapted so that the generated acoustic wave propagates according to modes characteristic of duct 7.

Duct 7 in which the fluid flows after acoustic focusing is a wave guide.

The concept of the wave guide is related to the fact that the walls of the tube have an impedance break with respect to the fluid.

The impedance is noted

Z=ρ*c

with “ρ” which corresponds to the density of the fluid and “c” which corresponds to the velocity of sound in the fluid.

As an example, a good reflector like steel has an impedance of 45×10⁶. Air with an impedance of 400 is also an excellent reflector. These impedances are to be compared to the impedance of water which is 1.5×10⁶.

The reflection coefficient R between material 1 and material 2 is defined by the formula:

R=abs[(Z1−Z2)/Z1+Z2)]

Ideally, we are looking for a coefficient R>0.6

By limiting itself to zero mode (axisymmetric mode) to simplify the approach, the sound pressure is written in this pipe:

P(r,z)=P₀J₀(kᵣ*r)Exp[i*(k_{z}*z+ω*†)]

with:

k_{z}²+kᵣ²=(ω/c)²

where

r is the radial position in the duct (tube)

z is the axial position

P₀ is the pressure module

ω=2*π*f is the beat

J₀ is the Bessel function of first species

c is the speed of sound in the liquid

k_{z} is the axial wave number

kᵣ is the radial wave number

The coupling between the fluid inside the duct (tube also called wave guide) and the wall of the tube is a condition of impermeability, which requires the radial velocity of the fluid to be equal to the normal velocity of the wall (radial displacement).

This coupling allows the deformation of the duct to be coupled to the radial wave number “kr”.

So, by writing the boundary condition for the inner radius of the tube, we have several families of waves meeting this boundary condition.

This condition makes it possible, for a given frequency f, to set a series of possible wave numbers. Depending on whether the radial wave number is a real or imaginary number, the waves in the tube will be propagating or evanescent.

According to the invention, for frequencies higher than 100 kHz, the duct (tube also called wave guide) has a diameter between 4 mm and 50 mm. The duct can be a multilayer tube of various materials, including metal, plastic or glass.

The inner layer is compatible with the fluid. On the other hand, the constitution of the other layers is random.

As an example, the duct or tube can be a simple steel pipe, or a thin plastic tube only capable of withstanding the pressure of the fluid. In the case of a steel pipe, the impedance breaking is ensured by the steel pipe alone, in the case of a thin plastic pipe the impedance breaking is ensured by the presence of air outside the pipe.

Depending on the sound power supplied by the piezoelectric elements 6, the device according to the invention can be applied to different industrial fields.

The Applicant was able to show that the device which is subject to the invention had the following advantages in particular:

the decomposition of the functions: acoustic source and focusing (the plane ceramic generates a plane wave and the focusing is provided by an external reflector, contrary to a bowl-shaped ceramic);

the possibility of mixing several acoustic sources of different frequencies in the same focusing mirror; the aim is for example to increase the probability of creating cavitation bubbles (several ceramics can generate acoustic waves which will be focused by the same reflector);

the fact that the treatment area is a compulsory fluid passage, i.e. all the fluid passes through duct 7 (the device is such that the outlet port is placed after the focusing and possibly after the wave guide tube);

the exposure time to the treatment can be controlled by controlling the flow rate (the flow rate sets the time of passage through the duct, the acoustic energy received by the treated fluid is controlled);

simple geometry favours in duct fluid handling;

the possibility to completely isolate the piezoelectric ceramic from the treated fluid; thus, the ceramic can be bonded on a substrate compatible with the liquid to be treated, and so the thickness will be optimized for the chosen operating frequency;

the materials used are common and low cost;

the possibility of propagating a high-power acoustic wave in the outlet tube after focusing, in particular by adapting the material of duct 7 (e.g. diameter and thickness);

the possibility of depressurizing the whole device in order to reach the cavitation threshold more easily, for example by using the device in suction instead of compression;

the fact that the device is particularly suitable for excitation in transient mode, which improves efficiency (exploitation of the effects of non-linearity of the acoustics: intermittent operation or excitation of several ceramics of different resonance frequencies focused in the same reflector);

the possibility of acoustic amplitude control; in cases where the desired effect is not to trigger cavitation, e.g. during homogenization or wall cleaning;

pulse-width modulation (PWM) control of the possible intermittent transmission;

acoustic frequency modulation over a frequency band; e.g. to avoid resonant modes in duct 7;

regulation of the flow rate of the possible treated fluid; and

the possibility of self-pumping (pumping effect of the fluid thanks to the non-linear effects of high-power acoustics).

The Applicant was able to demonstrate that, in the case of so-called “strong cavitation”, the bubble contains the gas phase of the liquid supporting the acoustic wave. The bubble subjected to sound pressure variations oscillates and then implodes. At implosion, very intense pressures are generated, as well as strong temperature rises. Light emissions can then be seen.

This “strong cavitation” is to be compared to “weak cavitation” for which the bubble consists of dissolved gases present in liquid 4. In this case there is no light radiation.

The use of very high-frequency ultrasound, preferably megasonic energy, allows for a very wide range of sound power without reaching strong cavitation. The device which is subject to the invention makes it possible to control the presence of strong cavitation, thanks to the characteristic acoustic signature of strong cavitation.

Advantageously, the Applicant has thus been able to demonstrate that megasonic wave treatment is particularly suitable for fragile substrates or products. The device 1 envisaged uses of very high frequency ultrasound, preferably megasonic energy, without ever reaching strong cavitation.

As shown in FIG. 3, the present invention also relates to a system 11 comprising at least two devices 1 according to the invention.

This system 11 further comprises a flow collector 9 which corresponds to the different outlets 8 of the different ducts 7 of the devices according to the invention.

The device according to the invention is used for treatment with acoustic waves.

According to the invention, treatment means the modification of the liquid or solid product to be treated, for example cleaning, stimulation, decontamination, sterilization, solubilization or mineralization.

Thus, the invention also relates to the use of a device or system according to the invention, for the treatment of liquid and/or solid products.

More particularly, the applicant was able to show that the device which was subject to the invention allowed:

the mineralization of products solubilized in liquid 4 also called carrier fluid;

the destruction of active ingredients such as pesticides or medicines, for example before discharge into wastewater;

water treatment in order to make it “drinkable” (environment, swimming pool treatment, etc.)

the destruction of microbes, viruses, microorganisms of all kinds.

the cleaning of endoscope-type tubes, said tube being placed in duct 7 or at its outlet 9, after the focusing mirror 10, which allows the removal and destruction of biofilms adhering to the walls;

local sterilization of products by using in particular a system 11 as shown in FIG. 3 in which the flow collector 9 acts as a high-pressure water cleaner.

The invention also aims to use a device or a system according to the invention for:

the extraction of active ingredients;

solubilization or homogenization of liquid and/or solid products in liquid 4;

the manufacturing of emulsion;

preparation of colloids; and/or

the preparation of chemical compounds.

More particularly, the applicant was able to show that the device or system which is subject to the invention allowed for:

rapid extraction of active ingredients from, for example, plants,

cellular lysis;

increasing the rate of solubilization of solids in a liquid;

the manufacturing of stable emulsions composed of several miscible products such as paints or cosmetics;

the preparation of colloids;

the preparation of chemical compounds by acoustic catalysis;

the dispersion, disaggregation or homogenization of products containing aggregates, in particular for the preparation of paints or creams;

Furthermore, the Applicant was able to show that the device according to the invention also allows for a production adapted to chemistry. Thus, instead of using chemically sensitive metals, it is possible to use compatible materials such as Pyrex, quartz or compatible coated metals.

According to an alternative mode of production of the invention, the device or associated system may be used for the treatment of animal-based food. Thus, the system is particularly well suited to the curing of foodstuffs, preferably the curing of animal-based foodstuffs, and even more preferably ham.

Surprisingly, the Applicant was able to demonstrate that the use of brine in a vessel or enclosure, followed by treatment of the food by the system according to the invention, allows, among other things, a reduction in brining time.

Thus, the invention also aims to use a system according to the invention, to brine foodstuffs inserted in an enclosure, preferably animal-based foodstuffs.

The Applicant was also able to demonstrate that the system which is subject to the invention modifies the metabolism of an organism, organ or tissue, preferably the ex vivo modification when the organism, organ or tissue is inserted into an enclosure.

According to the invention an organism is a complex, organized system. This is the product of successive variations over the course of evolution. It consists of one or more cells (from a unicellular organism or a multicellular organism).

According to the invention, an organ is a set of specific tissues from an organism capable of performing one or more specific functions.

According to the invention, a living tissue is the intermediate level of organization between the cell and the organ. A tissue forms a functional whole, i.e. its cells perform the same function.

It is preferred that the organism, organ or tissue is of animal or plant origin.

In particular, the Applicant was able to show, among other things, that the system made it possible to create uprooting forces in the boundary layer of certain plants.

According to the invention, the system can therefore be used to modify the exchanges between organisms, organs or tissues and a treatment fluid.

It appears that the creation of a mechanical stimulation on the cell surface is perceived by a living organism, preferably the plant, as a stress that modifies permeability (direct action on membrane channels, on lipids, on the transmembrane electrical potential, on the conformation of proteins, etc.). This mechanical stimulation triggers a cascade of cellular reactions, leading to neosynthesis of primary and secondary metabolites.

Advantageously, the system which is subject to the invention thus allows the metabolism of an organism, organ or tissue to be modified, preferably through ex vivo modification when the organism, organ or tissue is inserted in an enclosure, said modification allowing for example the neosynthesis of primary and/or secondary metabolites.

The system according to the invention can thus advantageously be used to modify the metabolism of organisms, organs or tissues either by stimulating or repressing the synthesis of cellular compounds.

Advantageously, the system which is subject to the invention can be used to modify the metabolism of an organism, organ or tissue by stimulating its growth. It is preferred that the organism is a plant organism, the organ is a plant organ and the tissue is a plant tissue.

The device which is subject to the invention may also be used to increase the defenses of a plant organism, plant organ or plant tissue against infection by a pathogenic agent which is preferably a fungus.

The Applicant was able to demonstrate that the treatment of roots by the device according to the invention stimulates plant growth and increases the defenses of the leaves against infection by a pathogenic fungus. These two examples show that the effects of the treatment are not limited to the treated organ, but induce an overall systemic response from the plant and a change in metabolism.

Another objective of the invention is a process for treating a solid product located in vessel 2, in and/or at the outlet of duct 7, with high-frequency acoustic waves, wherein it comprises the following steps according to which:

a liquid 4 is introduced into vessel 2 of a device 1 according to the invention via a flow circuit 5;

high-frequency acoustic waves of more than 100 kHz, preferably more than 200 kHz, are generated in said vessel 2 by the piezoelectric element (6);

the acoustic waves propagate in vessel 2 and focus at a point near the central part of opening 3 of the vessel and exit into duct 7; said waves allowing the treatment of the solid product; and

the treated solid product is then recovered.

According to a first method of production, liquid 4 is a treatment liquid allowing the treatment of the solid product.

According to a second method of production, liquid 4 is a liquid to be treated allowing both the solid product to be treated and also the product to be treated introduced into the flow circuit 5.

Finally, the last objective of the invention is a process for treating a liquid 4 with high-frequency acoustic waves, wherein it comprises the following steps according to which:

the liquid 4 to be treated is introduced into vessel 2 of a device 1 according to the invention via a flow circuit 5;

high-frequency acoustic waves of more than 100 kHz, preferably more than 200 kHz, are generated in said vessel 2 by the piezoelectric element 6;

the acoustic waves propagate in vessel 2 and focus at a point located near the central part of opening 3 of the vessel and exit into duct 7; said waves allowing the treatment of liquid 4; and

the liquid thus treated is recovered at the outlet of duct7 or at the outlet of flow collector 9.

The present invention will now be illustrated with the following examples.

### EXAMPLE 1

### Cleaning an Endoscope Contaminated with Bacteria, Viruses and Fungi

Cleaning is done by circulating bactericidal, sporicidal and virucidal products.

The processing time for one cycle is 30 minutes and there are three cycles.

The Applicant superimposes a propagating acoustic wave on this circulation. Thus, the internal walls of the endoscope will be subjected to strong pressure variations and a strong velocity gradient due to the acoustic boundary layer.

This allows the detachment of biofilm and microorganisms, which are carried along by the flow.

The frequency and sound power are adapted to the acoustic properties of the wave guide constituted by the endoscope tube, as the modes capable of propagating through the tube depend on the diameter and flexibility of its wall.

### EXAMPLE 2

### Preparation of Products to be Mixed

The device according to the invention can also be advantageously used for the preparation of mixtures.

The products to be mixed or reacted are fed into vessel 2 before the focusing area. Then the acoustics concentrated in duct 7 act as a catalyst. At the tube outlet, the final product is obtained.

The device is also suitable for making stable colloidal solutions.

1. A system comprising at least two devices for acoustic wave treatment, said devices comprising at least:
an open elongated vessel whose cross-section tapers progressively towards an opening on the upper part of said vessel, and
a piezoelectric element,
said vessel being filled with a liquid, the piezoelectric element capable of emitting waves into said liquid, said waves being focused near the opening of the vessel and emerging in a duct,
wherein the outlets of the individual ducts of the devices converge into a flow collector.

2. The system according to claim 1, wherein the liquid is:
a liquid to be treated, and/or a treatment liquid allowing a solid product located in the vessel to be treated, in and/or at the outlet of the duct.

3. The system according to claim 1, wherein the waves generated in the device by the piezoelectric element in the vessel and/or in the duct have a frequency above 100 kHz, preferably above 200 kHz.

4. The system according to claim 1, wherein the walls of the vessel and of the duct in the device are made of a hard material, capable of reflecting the waves, and are preferably shaped so as to cause the waves to focus at a point located near the central part of the opening of the vessel and/or in the central part of the duct.

5. The system according to claim 1, wherein the vessel of the device takes the shape of a paraboloid of revolution whose focal point is located near the central part of the opening of the vessel.

6. (canceled)

7. (canceled)

8. (canceled)

9. (canceled)

10. (canceled)

11. (canceled)

12. (canceled)

13. Method for treating a solid product located in the vessel, in and/or at the outlet of the duct of a device of a system according to claim 1, with high-frequency acoustic waves, wherein the method comprises:
introducing a liquid into the vessel of a device of a system according to claim 1 via a flow circuit;
generating high-frequency acoustic waves of more than 100 kHz in said vessel by the piezoelectric element;
treating a solid product with said high-frequency waves; wherein the acoustic waves propagate in the vessel and focus at a point located near the central part of the opening of the vessel and exit into the duct; and
recovering the treated solid product.

14. Method for treating a liquid with high-frequency acoustic waves in a device of a system according to claim 1, wherein the method comprises:
introducing a liquid to be treated into the vessel of said device by a flow circuit;
generating high-frequency acoustic waves of more than 100 kHz in said vessel by the piezoelectric element;
treating the liquid with said high-frequency waves; wherein the acoustic waves propagate in the vessel and focus at a point located near the central part of the opening of the vessel and exit into the duct; and
recovering the treated liquid at the outlet of the duct or at the outlet of the flow collector.

15. The method of claim 14, wherein generating high-frequency waves includes waves of more than 200 kHz.

16. The method of claim 14, wherein the liquid to be treated is a carrier fluid comprising solubilized substances therein, drinking water, or wastewater.

17. The method of claim 14, wherein treating the liquid decontaminates the liquids.

18. The method of claim 16, wherein treating mineralizes the solubilized substance within the carrier fluid.

19. The method of claim 14, wherein the treated liquid is an emulsion, colloid, or chemical compound resulting from treating the liquid.

20. The method of claim 13, wherein generating high-frequency waves includes waves of more than 200 kHz.

21. The method of claim 13, wherein the solid product includes a plant organism, plant organ, or plant tissue and treating the solid product comprises stimulating the growth of the solid product.

22. The method of claim 13, wherein the solid product includes a plant organism, plant organ, or plant tissue and treating the solid product comprises increasing the defenses of the solid product against infection by a pathogen.

23. The method of claim 13, wherein the solid product is a foodstuff and treating comprises brining the foodstuff.

24. The method of claim 23, wherein the foodstuff is an animal based foodstuff.

25. The method of claim 13, wherein treating the solid product decontaminates the solid product.

26. The method of claim 13, wherein treating the solid product extracts an active ingredient therefrom.

27. The method of claim 13, wherein treating the solid product comprises cellular lysis, increasing a rate of solubilization of a solid in a liquid.
